(19) United States
(12) Patent Application Publication
(10) Pub. No.: US 2015/0351415 A1
(43) Pub. Date: Dec. 10, 2015

(54) GLUTEN-FREE FOODS AND DOUGHS AND METHODS OF MAKING THEM

(71) Applicant: VSL Pharmaceuticals, Inc., Wilmington, DE (US)

(72) Inventors: Claudio DE SIMONE, Ardea RM (IT); Franco PIROVANO, Sulbiate MI (IT)

(21) Appl. No.: 14/686,587

(22) Filed: Apr. 14, 2015

Related U.S. Application Data
(63) Continuation of application No. 11/814,254, filed on Jul. 18, 2007, now abandoned.

(30) Foreign Application Priority Data
Mar. 16, 2005 (IT) PCT/IT2005/000144

(51) Int. Cl. A21D 8/04; A21D 10/02

(52) U.S. Cl. CPC A21D 8/045; A21D 8/042; A21D 10/025; A23Y 2220/03; A23Y 2220/29; A23Y 2220/15; A23Y 2240/75; A23Y 2220/67; A23Y 2220/17; A23Y 2300/29; A23Y 2300/45; A23Y 2300/55

(57) ABSTRACT

A mixture of at least 6 species of lactic acid bacteria and/or Bifidobacteria is disclosed for use in bakery and medical field. The preferred mixture comprises Streptococcus thermophilus, Bifidobacterium infantis, Bifidobacterium longum, Bifidobacterium breve, Lactobacillus acidophilus, Lactobacillus plantarum, Lactobacillus casei, Lactobacillus delbrueckii subsp. bulgaricus. Said mixture is useful for a sourdough, a leavening composition. Baked goods and other food products obtained therefrom are disclosed. These goods have low or no gluten content and are suitable for the integration of the diet of a subject suffering from celiac disease, for decreasing the risk of allergies due to wheat flour albumins and globulins, for the treatment of schizophrenic symptoms, in the preparation of products for enteric diet.

### CROSS REFERENCE TO RELATED APPLICATIONS

This U.S. utility patent application is a continuation of U.S. patent application Ser. No. 11/814,254, filed Jul. 18, 2007, now pending, which claims benefit of priority to international patent application no. PCT/EP06/60505, filed Mar. 7, 2006, which claims benefit of priority to international patent application no. PCT/IT2005/000144, filed Mar. 16, 2005. The contents of these applications are expressly incorporated herein by reference in their entirely for all purposes.

### FIELD OF THE INVENTION

The present invention relates to the manufacture of baked goods and, more in general, starchy food. In alternative embodiments provided are baked goods and other foods which are more digestible, they are gluten-free or have a reduced and markedly hydrolyzed gluten content and are particularly suitable for subjects affected by celiac disease.

### BACKGROUND OF THE INVENTION

Cereals are important components of the daily diet. Nevertheless wheat flour gluten, and in particular the gliadin fraction, are responsible for human intolerance. The celiac disease, also known as Celiac Sprue (CS) or gluten-sensitive enteropathy, is one of the diffuse food intolerance, occurring in 1 out of every 130 to 300 persons of the European and U.S. populations. In South America, North Africa and Asia, is generally underestimated (Fasano and Catassi; 2001, Gastroenterology, 120:636-651). The epidemiological distribution of CS is efficiently conceptualized by the iceberg model introduced by Logan in 1992 (Logan; 1992, Dyn. Nutr. Res. 2:14-24) where the prevalence of the disease is influenced by the frequency of the predisposing genotypes in the population. Total lifelong avoidance of gluten ingestion remains the cornerstone of CS treatment. The International Food Authority has now redefined the term gluten-free as zero tolerance for gluten, while the Codex Alimentarius permits a concentration of 200 ppm of gluten per food. Efforts to reduce the human intolerance to cereals are of a great medical, nutritional and economic interest. This is particularly true in the current context where the bakery industries are using very fast technological processes which may have an influence in the expanding epidemiology of CS.

Therefore, the need of more digestible and tolerated bread and baked products is really felt.

CS is an autoimmune disease of the small intestinal mucosa in genetically susceptible persons. Upon ingestion of gluten, these patients suffer from a self-perpetuating mucosal inflammation characterized by progressive loss of absorptive villi and hyperplasia of the crypts (Silano and De Vincenzi, 1999; Nahrung, 43:175-184). During endoluminal proteolytic digestion, for instance gliadins of wheat release a family of Pro- and Glu-rich oligopeptides that are responsible for the T-cell mediated immune response and/or, more in general, for the inflammatory state which characterizes the initial stage of CS (Silano and De Vincenzi; 1999). The literature reports the identification of the following oligopeptides: fragment 31-43 of the A-gliadin (Silano and De Vincenzi; 1999), fragment 62-75 of the α2-gliadin (Auricchio, S., et al.; 1996, Scand. J. Gastroenterol., 31:247-253; Picarelli, A., et al.; 1999, Scand. J. Gastroenterol., 34:1099-1102), the epitope 33-mer, which corresponds to the fragment 57-89 of the α2-gliadin (Shan, L., et al.; 2002. Science, 297:2275-2279), fragment 134-153 of γ-gliadin (Aleanzi, M., et al.; 2001, Clin. Chem., 47: 2023-2028) and the fragment 57-68 of α9-gliadin (Arentz-Hansen, et al.; 2000, J. Exp. Med., 191:603-612). Flours that are not tolerated by CS patients included wheat, rye, barley, kamut, triticale and spelt. Some controversy is still debated for oat.

Multidisciplinary research efforts are carried out in several fields to manage with CS. They concern the engineering of gluten free-grains (Fasano, A., et al.; 2003, Arch. Intern. Med., 163:286-292), search for the CS genes in humans (Fasano, A., et al.; 2003), use of some protective substances such as mannans and oligomers of N-acetylglucosammine and the use of a bacterial prolyl-endopeptidase from Flavobacterium meningosepticum as an oral supplementary therapy (Shan, et al.; 2002).

More recently, two articles showed the extensive hydrolysis of the gliadin fractions by selected sourdough lactobacilli such as Lactobacillus alimentarius 15M, L. brevis 14G, L. sanfranciscensis 7A and L. hilgardii 51B (Di Cagno, et al.; 2002, Appl. Environ. Microbiol., 68:623-33) and, especially, the tolerance of 17 CS patients to breads which contained 2 g of gluten, as determined by acute in vivo challenges based on the intestinal permeability (Di Cagno, et al.; 2004, Appl. Environ. Microbiol., 70:1088-1096). These results, although encouraging, at least in view of symptomatology, did not prove regression of histopathological damage.

Wei et al. (Wei, J. and Hemmings, G. P.; Medical Hypotheses, (2005), 64, 547-552) establish a genetic relationship between celiac disease and schizophrenia and report the beneficial effect of regression of schizophrenic symptoms in celiac patients treated with gluten-free diet (De Santis, A., et al.; J. Intern. Med. 1997; 242: 421-3).

The use of certain lactic acid bacteria in the manufacture of baked goods is already known.

U.S. Pat. No. 4,140,800, to Kline, discloses a process for making a freeze-dried sourdough bakery starter composition, which uses Lactobacillus sanfrancisco, with the aim to provide a product useful in the preparation of French bread. Desirably, the flour is high gluten.

The solution provided by Di Cagno et al., of using sourdough lactic acid bacteria still leave some practical problems unresolved. In particular, (i) selected strains are the results of a very long time consuming research which showed marked differences at strain level within the above species of sourdough lactic acid bacteria; (ii) the same results are obviously non reproducible at bakery plant; and, especially (iii) the selected strains are not commercially available.

Other references disclose the use of lactic acid bacteria and Bifidobacteria in food manufacturing.

EP 0 856 259 relates to a composition for feed use containing a mixture of lyophilized live bacteria comprising at least two species of bacteria selected from Bifidobacteria and at least two species of bacteria selected from Lactobacillus acidophilus, Streptococcus thermophilus, Lactobacillus bulgaricus, Lactobacillus casei, Lactobacillus plantarum and Streptococcus faecium and one or more oligosaccharides. The composition is added to a liquid, creamy or pasty foodstuff, said foodstuff being a milk, a milk-based or milk-derived product, or a product based on or derived from vegetable products, said supplementation being carried out at the moment of use of the foodstuff. The product is not used in bakery.

WO 03/071883 relates to dietetic and/or pharmaceutical compositions for human and/or animal use, and general foodstuffs, based on microbial cultures consisting of autochthonous and allochthonous species with respect to human beings and animals, selected from species of lactic bacteria, propionibacteria, yeasts and/or molds. They have an equilibrating action of the intestinal flora of the host human being or animal, as well as having various beneficial/probiotic effects towards the host organism. There is no indication of a possible use in celiac disease.

US 2004/265291 provides compositions, kits, and methods for providing or restoring beneficial bacteria to a subject. The compositions and kits optionally include food or nutrients to promote growth and proliferation of the bacteria in the subject or an antimicrobial agent to reduce the presence of undesirable or pathogenic microbes in the subject.

WO 02/065842 relates to starter preparations suitable for all types of cereal and the use of the same for producing bread and bakery products based on leaven or using leaven, especially for producing gluten-free bakery products for people with coeliac disease. There is no disclosure of particular mixtures of lactic acid bacteria and Bifidobacteria.

U.S. Pat. No. 5,185,165 discloses a precursor base for use in a bakery dough product comprising an acidic concentrate, at least one type of sugar, yeast, at least one type of flour, non-fat dry milk and at least one type of lactic acid producing bacteria and a process for producing the precursor base are disclosed. The precursor base is useful in a process for producing a precursor slurry (or active ferment concentrate) for use in making a preferment dough mixture for the preparation of the bakery dough product. In addition, processes for preparing the precursor slurry and the preferment dough mixture and an apparatus for producing the preferment dough mixture are disclosed. The reference to lactica acid bacteria is totally generic.

US 2004/110270 describes a bacterial composition having immunomodulation properties comprising at least one strain selected from the group consisting of Lactobacillus acidophilus PTA-4797, Lactobacillus plantarum PTA-4799, Lactobacillus salivarius PTA-4800, Lactobacillus paracasei PTA-4798, Bifidobacterium bifidum PTA-4801 and Bifidobacterium lactis PTA-4802.

EP 1 258 526 discloses the production of a starter for making wheat predough and wheat sourdough by partially fermenting a mixture of water and milled wheat product(s) with an inoculum comprising lactobacilli and yeast comprises using an inoculum comprising an adapted mixed flora including at least one yeast strain, at least one homofermentative lactobacillus strain and at least one heterofermentative lactobacillus strain. There are provided strains of Saccharomyces sp. DSM 14265, Lactobacillus pontis DSM 14269, Lactobacillus pontis DSM 14272, Lactobacillus pontis DSM 14273, Lactobacillus pontis DSM 14274, Lactobacillus crispatus DSM 14271, Lactobacillus plantarum DSM 14268 and Lactobacillus sanfranciscensis DSM 14270; an adapted mixed flora comprising Saccharomyces sp. DSM 14265 and at least three of Lactobacillus pontis DSM 14269, Lactobacillus pontis DSM 14272, Lactobacillus pontis DSM 14273, Lactobacillus pontis DSM 14274, Lactobacillus crispatus DSM 14271, Lactobacillus plantarum DSM 14268 and Lactobacillus sanfranciscensis DSM 14270. This reference pertains to the general technical filed of bakery products, with no special medical indications.

WO 99/09839 relates to a paste-like composition which is applicable for use as such and as a filling, coating or other component of various food products, and which contains a significant amount of probiotic. The food product is preferably a bakery product, in particular a rye-containing bread, rusk, biscuit or the like. This reference deals with the generally known aspects of use of probiotics.

The need of a baked product suitable for subjects affected by celiac disease, which can be obtained with an easy, reproducible process of manufacture and with materials reliable, safe and commercially available is still felt in this field.

The present invention meets these needs by providing a baked product for subjects affected by celiac disease. However, the baked product finds a general usefulness in human diet because of its higher digestibility.

### SUMMARY

It has now been found that certain specific mixtures of lactic acid bacteria and Bifidobacteria, of human and milk origin are endowed with the surprising property of being capable of hydrolyzing gliadin and glutenin fractions which are responsible for celiac disease.

These specific mixtures are very useful in the manufacturing of sourdough and provide well-defined bacterial species.

Therefore, it is an object of the present invention the use of specific mixtures of lactic acid bacteria and Bifidobacteria for the manufacture of sourdough.

Another object of the present invention is represented by cereal-based food, in particular baked goods which are generally more digestible and in particular can be tolerated by CS patients.

Another object of the present invention is a method for manufacturing cereal-based food, in particular baked goods suitable for subjects affected by celiac disease and suitable to prevent contamination of gluten in gluten-free products.

A further object of the present invention is represented by gluten-free cereal-based food, in particular baked goods made of wheat flour when the use of the specific mixtures of lactic acid bacteria and bifidobacteria is implemented under specific conditions with microbial proteolytic enzymes, routinely used in the bakery industries

Another object of the present invention is a food for subjects affected by celiac disease, said food containing the specific mixture of lactic acid bacteria and Bifidobacteria herein disclosed.

Still another object of the present invention is the use of the above mentioned mixtures of lactic acid bacteria and Bifidobacteria for the preparation of a product useful for reducing Platelet Activating Factor (PAF) and other inflammatory cytokines.

The details of one or more embodiments of the invention are set forth in the accompanying drawings and the description below. Other features, objects, and advantages of the invention will be apparent from the description and drawings, and from the claims.

All publications, patents, patent applications, cited herein are hereby expressly incorporated by reference for all purposes.

### BRIEF DESCRIPTION OF THE DRAWINGS

The drawings are illustrative of embodiments of the invention and are not meant to limit the scope of the invention as encompassed by the claims. The advantages, nature and additional features of the invention will appear more fully upon consideration of the illustrative embodiments described in the accompanying drawings. These and other objects of the present invention will be now disclosed in detail in the foregoing, also by means of examples and Figures, wherein:

FIG. 1 shows 2DE analysis of gliadin protein fractions of different doughs made of wheat flour. (A) Chemically acidified dough (control). Prolamin polypeptides were indicated by numbered red ovals. (B) Dough incubated for 24 h at 37° C. with MIXTURE 1 of the Example below. Prolamin polypeptides were indicated by numbered red ovals. Blue numbers refer to polypeptides which were degraded more than 80%. Mr, molecular mass.

FIG. 2 shows hydrolysis of 33-mer peptide by MIXTURE 1 (10⁹ cfu/ml). RP-FPLC at UV 214 nm trace of 200 μM 33-mer after 24 h of incubation at 37° C. without microbial inoculum (A) and after 24 h of hydrolysis by MIXTURE 1 at 37° C. (B).

### DETAILED DESCRIPTION OF THE INVENTION

According to the present invention, a mixture of at least 6, preferably at least 7, more preferably at least 8 species of lactic acid bacteria and/or Bifidobacteria selected from the group consisting of Lactobacillus acidophilus, Lactobacillus buchneri, Lactobacillus casei, Lactobacillus catenaforme, Lactobacillus cellobiosus, Lactobacillus crispatus, Lactobacillus curvatus, Lactobacillus delbrueckii, Lactobacillus delbrueckii subsp. bulgaricus, Lactobacillus delbrueckii subsp. lactis, Lactobacillus helveticus, Lactobacillus jensenii, Lactobacillus leichmannii, Lactobacillus minutus, Lactobacillus paracasei, Lactobacillus plantarum, Lacto bacillus rogosae, Lactobacillus salivarius, Lactobacillus brevis, Lactobacillus gasseri, Lactobacillus fermentum, Bifidobacterium adolescentis, Bifidobacterium angulatum, Bifidobacterium bifidum, Bifidobacterium breve, Bifidobacterium catenulatum, Bifidobacterium dentium, Bifidobacterium eriksonii, Bifidobacterium infantis, Bifidobacterium lactis, Bifidobacterium longum, Bifidobacterium plantarum, Bifidobacterium pseudo-catenulatum, Bifidobacterium pseudolongum, Streptococcus lactis, Streptococcus raffinolactis, Acidaminococcus fermenta, Cytophaga fermentans, Rhodoferax fermentans, Cellulomonas fermentans, Zymomonas mobilis, Streptococcus thermophilus are suitable for carrying out the present invention.

Other species can be used, for example those disclosed in the state of the art and generally available in collections, such as ECACC, ASTM; DSM.

The preferred mixtures according to the present invention are the following:

Streptococcus thermophilus,
Bifidobacterium infantis,
Bifidobacterium longum,
Bifidobacterium breve,
Lactobacillus acidophilus,
Lactobacillus plantarum
Lactobacillus casei,
Lactobacillus delbrueckii subsp. bulgaricus.
Streptococcus thermophilus,
Bifidobacterium lactis,
Bifidobacterium breve,
Lactobacillus acidophilus
Lactobacillus plantarum,
Lactobacillus casei,
Lactobacillus helveticus.

These mixtures of well known species can be easily prepared by any person having ordinary experience in this field.

Conveniently, these mixtures are commercially available in a lyophilized form.

These formulations are suitable for use as starter in the preparation of sourdough.

The cereal-based food, in particular baked goods obtained according to the present invention are generally more digestible, therefore are more accepted by the general consumer or particularly by people wishing or needing more digestible food.

In a particular embodiment of the invention, the cereal-based food, in particular baked goods can be used for the integration of the diet of people affected by celiac disease, since gluten concentration is reduced to a low value and the amount of gluten which persisted in the dough is markedly hydrolyzed, especially for the peptide sequences which are responsible for CS.

When one of the above microbial mixtures is integrated with a sufficient amount of microbial protease, such as for example 200 ppm of microbial protease (typically from Aspergillus sp.) under the conditions optimized in the present invention the fermented sourdough has a concentration of gluten lower than 200 ppm, as determined by using the monoclonal antibody R5. As stated by the Codex Alimentarius such type of product is defined gluten-free and therefore suitable for celiac patients.

Microbial proteases are of common use in bakery, see for example WO 88/03365, EP 0588426, U.S. Pat. No. 6,465,209, GB1,196,946. These proteases are commonly marketed, see for example Enzyme Development Corporation U.S.A. and the present invention can be carried out with any product available on the market and of common use in bakery.

In a preferred embodiment of the present invention, the microbial protease is a fungal protease from Aspergillus oryzae; activity of 500,000 HUT/g; pH optimum about 3.0 and activity in the range of pH 3.0 to 6.0; temperature optimum about 50° C. and activity in the range 25-60° C.; or another protease is an acid stable protease from Aspergillus niger; activity of 3,000 SAPU/g; optimum pH 2.0-3.0 and activity in the range of pH 2.0 to 6.0; temperature optimum 50-60° C. and activity in the range 30-60° C. These enzymes are available from Bio-Cat Inc., Troy, Va., U.S.A. and many other suppliers.

The present invention allows making baked goods with a higher percentage of wheat flour, resulting in products with a more agreeable flavor and better accepted by people affected by celiac disease. The present invention also allows to obtain products directed to general consumers, including healthy people, endowed with better digestibility.

In a wider aspect, the present invention also refers to starchy products comprising a mixture of lactic acid bacteria, optionally supplied with enzymatic preparations as disclosed above.

In its widest aspect, the present invention provides a mixture of lactic acid bacteria and Bifidobacteria, optionally added with proteolytic enzymes of microbial origin, useful for the preparation of products for oral administration for improving digestion of gluten and gluten-related substances.

The sourdough comprising the specific mixture of the present invention is the critical aspect of the same.

The sourdough is useful in a process for the preparation of a baked good, in particular bread, but this applies to all leavened and non-leavened products, such as for example biscuits, pastries, cakes, pies, pizza, crackers, breadsticks, snacks and all other products known in the art.

The sourdough according to the present invention is suitable also for preparations for making, also homemade making, cereal-based food, in particular baked goods. In this case, the package for a baked good will comprise, other than usual ingredients for the specific product, a leavening preparation comprising the specific mixture of the present invention.

The leavening preparation according to the present invention can be a combination with the specific mixture of lactic acid bacteria and Bifidobacteria or can be provided in the package separately with the lactic acid bacteria and Bifidobacteria mixture and will be mixed with this latter at the moment of use, for example in water to form a leavening suspension. The mixture of lactic acid bacteria can be packaged in a single container alone or in admixture with the proteolytic enzymes (protease) disclosed above.

Starchy products are generally well-known in the field and are part of the common knowledge, also among consumers and homemade cooking. In particular, the present invention is applied to cereal-based products.

Examples of starchy products are all kinds of pasta, noodles, such as fried instant noodles and wet noodles, snack products, tortillas, corn chips, extruded cereals and shredded cereals.

Methods for making pasta are well-known in the art and reference is made just for example to Pasta and Semolina Technology, Edited by R. C. Kill and K. Turnbull, Blackwell Science, 2001 and patents owned by Barilla. Methods for making Asian starchy products are also well-known and just exemplary reference is made to Asian Food, Science and Technology, Edited by Catharina Y. W. Ang, KeShun Liu and Yao-Wen Huang, Technomic Publishing Company, Inc., 1999 and US 20020160093 to Kao Corporation and WO 99/65331, to Societé de Produits Nestlé S. A.

Today, most pasta is manufactured by continuous, high capacity extruders, which operate on the auger extrusion principle in which kneading and extrusion are performed in a single operation. The manufacture of pasta includes dry macaroni, noodle, and spaghetti production.

Pasta products are produced by mixing milled wheat, water, eggs (for egg noodles or egg spaghetti), and sometimes optional ingredients. These ingredients are typically added to a continuous, high capacity auger extruder, which can be equipped with a variety of dies that determine the shape of the pasta. The pasta is then dried and packaged for market.

Pasta products contain milled wheat, water, and occasionally eggs and/or optional ingredients. Pasta manufacturers typically use milled durum wheat (semolina, durum granulars, and durum flour) in pasta production, although farina and flour from common wheat are occasionally used. Most pasta manufacturers prefer semolina, which consists of fine particles of uniform size and produces the highest quality pasta product. The water used in pasta production should be pure, free from off flavors, and suitable for drinking. Also, since pasta is produced below pasteurization temperatures, water should be used of low bacterial count. Eggs (fresh eggs, frozen eggs, dry eggs, egg yolks, or dried egg solids) are added to pasta to make egg noodles or egg spaghetti and to improve the nutritional quality and richness of the pasta. Small amounts of optional ingredients, such as salt, celery, garlic, and bay leafs, may also be added to pasta to enhance flavor. Disodium phosphate may be used to shorten cooking time. Other ingredients, such as gum gluten, glyceryl monostearate, and egg whites, may also be added. All optional ingredients should be clearly labeled on the package.

Durum wheat is milled into semolina, durum granular, or durum flour using roll mills. Semolina milling is unique in that the objective is to prepare granular middlings with a minimum of flour production. After the wheat is milled, it is mixed with water, eggs, and any other optional ingredients.

In the mixing operation, water is added to the milled wheat in a mixing trough to produce dough with a moisture content of approximately 31 percent. Eggs and any optional ingredients may also be added. Most modern pasta presses are equipped with a vacuum chamber to remove air bubbles from the pasta before extruding. If the air is not removed prior to extruding, small bubbles will form in the pasta which diminish the mechanical strength and give the finished product a white, chalky appearance.

After the dough is mixed, it is transferred to the extruder. The extrusion auger not only forces the dough through the die, but it also kneads the dough into a homogeneous mass, controls the rate of production, and influences the overall quality of the finished product. Although construction and dimension of extrusion augers vary by equipment manufacturers, most modern presses have sharpedged augers that have a uniform pitch over their entire length. The auger fits into a grooved extrusion barrel, which helps the dough move forward and reduces friction between the auger and the inside of the barrel. Extrusion barrels are equipped with a water cooling jacket to dissipate the heat generated during the extrusion process. The cooling jacket also helps to maintain a constant extrusion temperature, which should be approximately 51° C. (124° F.). If the dough is too hot (above 74° C. [165° F.]), the pasta will be damaged.

Uniform flow rate of the dough through the extruder is also important. Variances in the flow rate of the dough through the die cause the pasta to be extruded at different rates. Products of nonuniform size must be discarded or reprocessed, which adds to the unit cost of the product. The inside surface of the die also influences the product appearance. Until recently, most dies were made of bronze, which was relatively soft and required repair or periodic replacement. Recently, dies have been improved by fitting the extruding surface of the die with Teflon® inserts to extend the life of the dies and improve the quality of the pasta.

Drying is the most difficult and critical step to control in the pasta production process. The objective of drying is to lower the moisture content of the pasta from approximately 31 percent to 12 to 13 percent so that the finished product will be hard, retain its shape, and store without spoiling.

Most pasta drying operations use a preliminary drier immediately after extrusion to prevent the pasta from sticking together. Predrying hardens the outside surface of the pasta while keeping the inside soft and plastic. A final drier is then used to remove most of the moisture from the product.

Drying temperature and relative humidity increments are important factors in drying. Since the outside surface of the pasta dries more rapidly than the inside, moisture gradients develop across the surface to the interior of the pasta. If dried too quickly, the pasta will crack, giving the product a poor appearance and very low mechanical strength. Cracking can occur during the drying process or as long as several weeks after the product has left the drier. If the pasta is dried too slowly, it tends to spoil or become moldy during the drying process. Therefore, it is essential that the drying cycle be tailored to meet the requirements of each type of product. If the drying cycle has been successful, the pasta will be firm but also flexible enough so that it can bend to a considerable degree before breaking.

Packaging keeps the product free from contamination, protects the pasta from damage during shipment and storage, and displays the product favorably. The principal packaging material for noodles is the cellophane bag, which provides moisture-proof protection for the product and is used easily on automatic packaging machines, but is difficult to stack on grocery shelves. Many manufacturers utilize boxes instead of bags to package pasta because boxes are easy to stack, provide good protection for fragile pasta products, and offer the opportunity to print advertising that is easier to read than on bags.

Air emissions may arise from a variety of sources in pasta manufacturing. Particulate matter (PM) emissions result mainly from solids handling and mixing. For pasta manufacturing, PM emissions occur during the wheat milling process, as the raw ingredients are mixed, and possibly during packaging. Emission sources associated with wheat milling include grain receiving, precleaning/handling, cleaning house, milling, and bulk loading. Other information are available in D. E. Walsh and K. A. Gilles, “Pasta Technology”, Elements Of Food Technology, N. W. Desrosier, Editor, AVI Publishing Company, Inc., 1977

The present invention is applicable both to the industrial manufacture and the home preparation of pasta, in the latter case, favourably in the preparation of egg pasta.

According to the present invention, in the process of making dough, the mixture of lactic acid bacteria herein disclosed are used.

In another embodiment of the present invention, typical Asian, cereal-based food is provided. A preferred example is a kind of noodle known as Ramyun in Korea, Ramien in China and Ramen in Japan.

As in the general carrying out of the present invention, the dough is prepared by adding the mixture of lactica acid bacteria and letting the sufficient time for pre-fermentation.

The mixtures of lactic acid bacteria and Bifidobacteria according to the present invention, optionally added with the above mixtures of microbial proteases, can also be used in the manufacture of a food, in particular gluten-free grade, for consumption by a subject affected by celiac disease. Examples of this kind of food are pastas, cereals, tacos, tortillas, popcorn. For a reference see Practical Gastroenterology—April 2004, pages 86-104 and the literature cited therein.

Another object of the present invention is a method for the manufacture of a baked good comprising the addition of the above sourdough preparation.

In a preferred embodiment of the present invention, the method comprises the following steps:

a) liquid pre-fermentation of 20-50% of wheat flour by weight (whole mixture 20%-50% of flour and 80%-50% of water, dough yield about 300 with about 10⁹ cells of the mixture of the present invention per g of dough), at about 37° C. for at least about 24 h, preferably between about 24 and about 31 hours;
b) after fermentation, mixing the dough with one or more tolerated flour, such as millet flour, to have a final dough yield of about 150 (solid dough) and added of commercial baker's yeast at a concentration of about 1% by weight;
c) incubating the dough at about 37° C. for about 2 hours until the leavening is completed;
d) baking at about 250° C. for about 20 minutes.

In a second embodiment of the present invention, the method can be modified as follows:

a) liquid fermentation of 20% of wheat flour with the further addition of fungal proteases (200 ppm) at 37° C. for 24-31 hours;
b) after fermentation, drying to remove water in order to have a gluten-free wheat flour (<200 ppm of gluten);
c) use of the wheat flour gluten-free as basic ingredient for the manufacture of cereal-based food, in particular baked goods.

The term “about” in this circumstance means those values around those indicated which are comprised in normal carrying out of the invention and can depend on the instrumental errors of the measuring devices or deviations made by the person skilled in the art around the indicated values, but that do not affect the result obtained by the invention.

The above ranges are intended also as about higher than the lower limit and about lower than the upper limit. Therefore, the liquid pre-fermentation of step a) comprises an amount of wheat flour not lower than about 20% and not higher than 50% by weight for a time of not less than about 24 hours and not more than about 31 hours.

An exemplary list of tolerated flours comprises bean flours, buckwheat, flax, corn (maize), legume flours (garbanzo/chickpea, lentil, pea), millet, Indian Rice Grass, nut flours (almond, hazelnut, pecan), quinoa, potato flour, sweet potato flour, sago, seed flours (sesame), sorghum, soy, tapioca, teff. Millet is one of the preferred tolerated flours.

A very advantageous embodiment of the present invention is to include a prebiotic in the baked good, whether containing or not a tolerated flour.

A prebiotic is a non-digestible fibre-like substance, examples of which are short chain and long chain oligosaccharides, such as fructo-oligosaccharides, soyoligosaccharides, xylo-oligosaccharides and isomalto-oligosaccharides.

An even more advantageous embodiment of the invention is the incorporation of the baked good herein disclosed in a baked good such as the one disclosed in EP 1 010 372. In this embodiment, the baked good comprises a non-baked, essentially water-free, fat-based composition comprising live lyophilized lactic bacteria. This fat-based composition comprising live lyophilized lactic bacteria can of course be combined with all the baked products of the present invention.

The cereal-based food, in particular baked goods and the packages for the making cereal-based food, in particular baked goods according to the present invention are suitable for administration to a subject suffering from celiac disease.

As said above, the present invention comprises also general food known under the general name of starchy food, in particular cereal-based food.

The mixture of lactic acid bacteria, optionally added with the microbial protease, as previously described, is used in the manufacture of starchy food, in particular cereal-based food to obtain the same results and advantages of the above described embodiment of baked goods. So to say, the food obtained according to the present invention is suitable for subjects suffering from celiac disease or for general consumers, also in good health, wishing more digestible food. For example children and ageing people may wish more digestible food.

Therefore, a further object of the present invention is a method for treating a subject suffering from celiac disease comprising the integration of the diet of said subject with a baked good and/or a starchy food as disclosed above. In the foregoing, the baked goods and the starchy food according to the present invention will be comprised in the term “cereal-based food”.

In another embodiment of the present invention, the cereal-based food, in particular baked goods can also be used for maintaining gluten tolerance or for inducing gluten tolerance or for decreasing the risk of allergies due to wheat flour albumins and globulins.

In another embodiment of the present invention, the cereal-based food, in particular baked goods can be safety used for celiac patients since the low concentration of gluten (<200 ppm).

The methods of treatment according to the present invention can also be used in combination with other medical treatments for celiac disease.

As reported above, schizophrenic symptoms are noted in celiac patients and schizophrenic patients show sensitive behavior to gluten. The mixtures according to the present invention are useful for preparing gluten-free dietetic goods.

Therefore, a further object of the present invention is the use of the mixture disclosed above in the preparation of a gluten-free dietetic good useful for the treatment of schizophrenic symptoms. In particular, said symptoms affect a celiac or a non-celiac patient.

Another problem in the art is the use of proline in preparations for enteric diet. In certain subjects, proline is not hydrolyzed and the compounds making the solution for enteric diet are not assimilated. Also allergic responses can occur due to proline. The mixtures of lactic acid bacteria and Bifidobacteria disclosed in the present invention are useful for hydrolyzing proline or proline-enriched peptides, thus making preparations for enteric diet effective and non-allergenic.

Thanks to their properties, the mixtures of lactic acid bacteria and Bifidobacteria disclosed in the present invention are also useful for making gliadin-enriched glutamine solutions hypoallergenic.

In another embodiment of the present invention, it has also been found that the mixtures herein disclosed can be used in the manufacture of a product for lowering the levels of Platelet Activating Factor (PAF) and other inflammatory cytokines for treating gastro-intestinal disease.

PAF is involved in a series of gastro-intestinal diseases, in particular inflammatory disorders. We can mention ischemic bowel necrosis (Hsueh W., Gonzalez-Crussi F.; Methods Achiev. Exp. Pathol.; 1988:13; 208-39), gastric ulcer (Esplugues J V., Whittle B. J., Methods Find.; 1989: Suppl. 1, 61-6), hemorrhagic rectocolitis (Chaussade S., Denizot Y, Ann. Gastroenterol. Hepatol. (Paris); 1991, May 27(3): 117-21), necrotizing enterocolitis (Ewer A K., Acta Pediatr. Suppl.; 2002, 91(437): 2-5; neonatal: Caplan M S., et al., Semin. Pediatr. Surg.; 2005, August 14(3): 154-51), inflammatory bowel disease (Nassif A., et al. Dis. Colon Rectum; 1996, February; 39(2):217-23), pouchitis (Rothenberg D A., et al. Ann. Chir.; 1993; 47(10):1043-6).

In view of the above explanation, the product according to the present invention can also be supplemented to subjects, in particular Japanese pople, having a deficit in PAF-hydrolase, who can be affected by a series of inflammatory diseases (Karasawa K; et al.; Prog. Lipid. Res.; 2003 March, 42(2):93-114). The product can take the form of a food, as disclosed above, or a nutritional supplement, a nutraceutical, a drug.

Nutritional supplement and nutraceutical are well-known terms in the art (Aryanitoyannis I S, et al.; Crit. Rev. Food Sci. Nutr.; 2005,45(5):385-404 and Kalra E K, AAPS Pharm Sci.; 2003, 5(3); E25) and there is no need of further definition.

The following example further illustrates the invention.

### Example 1

### Sourdough Fermentation and Electrophoresis Analyses

The characteristics of the wheat flour used were as follows: moisture, 12.8%; protein (N×5.70), 10.7% of dry matter (d.m.); fat, 1.8% of d.m.; ash, 0.6% of d.m.; and total soluble carbohydrates, 1.5% of d.m. Eighty grams of wheat flour and 190 ml of tap water (containing a cell concentration of the cell preparations of about 10⁹ cfu per g of dough) were used to produce 270 g of dough (dough yield, 220). Four doughs were manufactured by using the following mixtures of lactic acid bacteria and Bifidobacteria.

Mixture 1 according to the invention:

Streptococcus thermophilus,
Bifidobacterium infantis,
Bifidobacterium longum,
Bifidobacterium breve,
Lactobacillus acidophilus,
Lactobacillus plantarum
Lactobacillus casei,
Lactobacillus delbrueckii subsp. bulgaricus.

Mixture 2 according to the invention

Streptococcus thermophilus,
Bifidobacterium lactis,
Bifidobacterium breve,
Lactobacillus acidophilus
Lactobacillus plantarum,
Lactobacillus casei,
Lactobacillus helveticus.

Mixture 3

Lactobacillus acidophilus,
Lactobacillus brevis,
Streptococcus thermophilus,
Bifidobacterium infantis.

Mixture 4

Lactobacillus brevis,
Lactobacillus salivarius spp. salicinius
Lactobacillus plantarum

Fermentation was carried out at 37° C. for 24 h. A dough without bacterial inoculum was chemically acidified to pH 4.0 with a mixture of lactic and acetic acids (molar ratio 4:1) and used as control. After incubation, gliadins were extracted from doughs following the method originally described by Osborne (Osborne, T. B.; 1970, The proteins of the wheat kernel. Carnegie Institute of Washington publication 84. Judd and Detweiler, Washington, D.C.) and further modified by Weiss et al. (Weiss, et al.; 1993, Electrophoresis, 14:805-816).

Aliquots of 10-20 μl (about 10 μg of gliadin) were diluted 1:1 with sample buffer, treated at 100° C. for 5 min and analyzed by sodium dodecyl sulfate-polyacrylamide gel electrophoresis (SDS-PAGE) according to the Laemmli procedure (Laemmli; 1970, Nature, 227:680-685); the gels contained 12% of acrylamide and were stained with B10 Bio-Safe Coomassie blue (Bio-Rad Laboratories, Hercules, Calif.). Two-dimensional gel electrophoresis (2DE) was performed as described by Di Cagno et al. (Di Cagno; et al., 2004). Three gels were analyzed, and spot intensities of chemically acidified dough (siCAD) and sourdough (added of MIXTURE 1) (siSD) were normalized as reported by Bini et al. (Bini, et al.; 1997, Electrophoresis, 18:2832-2841). The hydrolysis factor for individual proteins was expressed as [(siCAD−siSD)/siCAD]×100. All the hydrolysis factors were calculated based on the average of the spot intensities of the three gels, and standard deviation was calculated. Only hydrolysis factors with statistical significance where P value was <0.05 were reported.

Hydrolysis of Synthetic Substrates, Pro-Rich Polypeptides and RP-FPLC Analyses

Preliminarily, the proline specific peptidase activities of Mixture 1 were characterized by using synthetic substrates such as Pro-p-NA, Leu-p-NA, Ala-p-NA, Leu-Leu, Val-Leu, Pro-Gly, Gly-Pro-Ala, Leu-Leu-Leu, Z-Gly-Pro-p-NA and NCBZ-Gly-Gly-Leu-p-NA (Sigma Chemical Co, St. Louis, Mo.). The assay mixture contained 500 μl of 200 mM phosphate buffer, pH 7.5, 150 μl of substrate (0.2-3 mM, final concentration), 8 μl of NaN₃ (0.05% final concentration) and 50 μl of MIXTURE 1 preparation (5×10⁹ cfu/ml, final concentration). Fragment 62-75 (P-Q-P-Q-L-P-Y-P-Q-P-Q-S-F-P) of the A-gliadin (Silano and De Vincenzi; 1999) and the epitope 33-mer (L-Q-L-Q-P-F-P-Q-P-Q-L-P-Y-P-Q-P-Q-L-P-Y-P-Q-P-Q-L-P-YP-Q-P-Q-P-F) (Shan et al., 2002) were chemically synthesized by Neosystem Laboratoire (Strasbourg, France). The assay mixture for the fragment 62-75 contained 320 μl of 20 mM phosphate buffer, pH 7.0, 150 μl of substrate (450 μM, final concentration), 8 μl of NaN₃ (0.05% final concentration) and 50 μl of MIXTURE 1 preparation (5×10⁹ cfu/ml, final concentration). The assay mixture for the epitope 33-mer contained 500 μl of 200 mM phosphate buffer, pH 7.5, 150 μl of substrate (200 μM, final concentration), 8 μl of NaN₃ (0.05% final concentration) and 50 μl of MIXTURE 1 preparation (5×10⁹ cfu/ml, final concentration). Both the mixtures were incubated at 37° C. under stirred conditions (150 rpm). The enzyme kinetics for the hydrolysis of the 33-mer was calculated by using a Lineweaver-Burk plot (Lineweaver and Burk; 1934, J. American Chem. Soc., 56:658-666).

The enzyme reactions were stopped by addition of 0.05% (vol/vol) (final concentration) trifluoroacetic acid. Peptides were separated from the mixture by RP-FPLC using a Resource II RPC 3 ml column and FPLC equipment with a UV detector operating at 214 nm (Amersham Bioscences, Upssala, Sweden). Elution was at flow rate of 1 ml/min with a gradient (5 to 100%) of acetonitrile in 0.05% trifluoroacetic acid. The concentration of CH₃CN was increased linearly from 5 to 46% between 16 and 62 min and from 46% to 100% between 62 and 72 min.

The same procedure was used to determine the oligopeptides contained in the 70% ethanol-soluble extracts of the fermented doughs.

Use of Fungal Proteases in Association with Lactic Acid Bacteria and Bifidobacteria

To produce a gluten-free sourdough (<200 ppm), MIXTURE 1 was used in association with 200 ppm of fungal proteases routinely used in bakery products. During fermentation, the complementary activity of the proteolytic activities from bacteria and fungal sources gave a marked decrease of the of especially gliadin and glutenin fractions. The ethanol-soluble extracts of the fermented sourdough showed a gluten concentration lower than 200 ppm as determined by the use of the monoclonal antibody R5.

Western Blot Analysis with R5 Monoclonal Antibody and RAPD PCR Analysis

Fermented dough (37° C. for 24 h) with MIXTURE 1 (about 10⁹ cfu per g of dough) was mixed with non protein ingredients and tolerated flour (e.g., millet) to produce Italian biscuits and subjected to baking at 250° C. for 15 min. Italian biscuits manufactured without fermentation with MIXTURE 1 were used as control. Biscuits were analyzed by Western blot R5 monoclonal antibody and RAPD PCR at the Centro National de Biotecnologia, Gluten Unit, CNB (28049 Madrid Spain). R5 monoclonal antibody recognizes potential toxic celiac peptides: QQPFP and 33-mer. RAPD PCR was carried based on specific DNA sequences which are related to potential toxic peptides.

Hydrolysis of Wheat Flour Salt Soluble Proteins (Albumins and Globulins)

Albumins and globulins were extracted from wheat flour by the method of Weiss (1993). The assay mixture, containing 0.8 ml of albumins/globulins (about 3 mg/ml) in 50 mM Tris-HCl, pH 7.0, 5×10⁹ cfu/ml of MIXTURE 1 and NaN₃ 0.05%. Incubation was at 37° C. for 24 h under stirred conditions. A control without microbial cells was included in the test. After incubation, the supernatant was recovered by centrifugation and used for electrophoresis. Proteins from water/salt soluble fraction (albumins and globulins) were analyzed by immunoblotting (Curioni, A., et al., 1999, Clin. Exp. Allergy, 29:407-413) to detect the IgE binding of pooled sera from atopic patients, previously characterized as suffering from gastrointestinal symptoms related to wheat ingestion. By using a semidry blotting, protein bands, separated by SDS-PAGE, were transferred onto nitrocellulose sheets with a Trans-blot Cell (Bio-Rad Laboratories, Milan, Italy) with a transfer buffer containing 48 mM Tris, pH 9.2, 39 mM glycine, 20% methanol and 0.1% SDS, for 5 h at the voltage of 50 V. Blotting bands were visualized by soaking the membranes for a few minutes in Ponceau S (0.1% in 3% trichloroacetic acid) and marked with a pencil, before destaining with water. Membranes were blocked with TBS containing 0.05% Tween 20 (TBS-T) and 5% skim milk powder (M-TBS-T) for 2 h, and incubated overnight with pooled sera from patients, diluted 1:20 in TBS-T. After washing five times with M-TBS-T, blots were incubated for 1 h with monoclonal antihuman IgE peroxidase-conjugate antibody (Sigma Chemical Co), diluted 1:5000 in M-TBS-T (Curioni, et al.; 1999). After four washes in M-TBS-T and one in TBS, bound IgE were visualized by chemiluminescence using the Supersignal Detection kit (Pierce Biotechnology Inc., Rockford, Ill.), according to the instructions provided by the manufacturer. The procedure was carried out at room temperature.

Compared to the control, the SDS-PAGE profiles of the gliadin fractions extracted from the doughs fermented with the four cell preparations showed that not all the cell preparations had the same capacity to degrade gliadins. Hydrolysis was very high for MIXTURE 1 of the invention, just slight for MIXTURE 2, while the other cell preparations (MIXTURES 3 and 4) did not cause an appreciable degradation.

The differences among the four cell preparations were confirmed by the RP-FPLC analysis of the 70% ethanol soluble protein fractions which gave an overall view of the oligopeptides with apparent molecular masses lower than those detectable by electrophoresis.

The above results gave a great evidence of the highest performance of the MIXTURE 1 which seemed to have a proteolytic activity more specifically addressed to gliadins.

When the bacterial species which composed MIXTURE 1 were used individually at the same concentration of about 10⁹ cells per g of dough, none of the 8 species gave a marked hydrolysis as shown by the mixture. This was the first evidence of the complementary proteolytic activity between the species of at least 6 strains which are used in MIXTURE 1 in well defined proportion.

Gliadins and related oligopeptides are characterized by a large proportion of proline residues within their sequences (Wieser, 1996, Acta Pediatr. Suppl. 412:3-9). Proline is unique among the 20 amino acids because of its cyclic structure. This specific conformation imposes many restrictions on the structural aspects of peptides and proteins, making them extremely resistant to hydrolysis. To adequately deal with such peptides, a group of specific peptidases is necessary to hydrolyze all the peptide bonds in which a proline residue occurs as potential substrate at the different positions (Cunningham and Connor; 1997, Biochim. Biophys. Acta, 1343: 160-186). Preliminarily, the proline specific peptidase activities of MIXTURE 1 were characterized by using synthetic substrates such as Pro-p-NA, Leu-p-NA, Ala-p-NA, Leu-Leu, Val-Leu, Pro-Gly, Gly-Pro-Ala, Leu-Leu-Leu, Z-Gly-Pro-p-NA and NCBZ-Gly-Gly-Leu-p-NA which are relatively specific for proline iminopeptidase, aminopeptidase, dipeptidase, prolinase, prolidase, dipeptidyl peptidase, tripeptidase, prolyl-endopeptidase and endopeptidase enzymes, respectively (Table 1).

TABLE 1
Enzyme activities of MIXTURE 1.

| | | Substrate | |
|---|---|---|---|
| | | concentra- | Unit of |
| Substrate | Type of enzyme | tion (mM) | activity (U) |
| Pro-p-NA | Proline iminopeptidase | 2 | 3.2 ± 0.02 |
| Leu-p-NA | Aminopeptidase | 2 | 8.4 ± 0.04 |
| Ala-p-Na | Aminopeptidase | 2 | 12.3 ± 0.05 |
| Leu-Leu | Dipeptidase | 2 | 15.51 ± 0.03 |
| Val-Leu | Dipeptidase | 2 | 17.22 ± 0.07 |
| Pro-Gly | Prolinase | 3 | 8.0 ± 0.02 |
| Val-Pro | Prolidase | 2 | 3.03 ± 0.02 |
| Gly-Pro-Ala | Dipeptidyl peptidase IV/ | 2 | 2.73 ± 0.01 |
| | carboxypeptidase P | | |
| Leu-Leu-Leu | Tripeptidase | 2 | 10.63 ± 0.41 |
| Z-Gly-Pro-p-NA | Prolyl-endopeptidase | 2 | 1.3 ± 0.01 |
| NCBZ Gly-Gly- | Endopeptidase | 2 | 1.9 ± 0.02 |
| Leu-p-NA | | | |

Each value is the average of three enzyme assays, and standard deviations were calculated. A unit of enzyme activity (U) on p-NA substrates was defined as the amount of enzyme which produced an increase in absorbance at 410 of 0.01/min. A unit on polypeptides was the amount of enzyme which liberates 1 micromole of substrates/min.

All the above enzyme activities were largely distributed in the MIXTURE 1 preparation. Since it is very rare that a unique microbial strain may possess all the previous enzyme activities (Cunningham and O'Connor; 1997; Kunjii, et al.; 1996, Antoine Van Leeuwenhoek 70:187-221; Di Cagno et al.; 2004), only a pool of selected bacteria such as those contained in the MIXTURE 1 may have the complete pattern of peptidases needed for hydrolysis of Pro-rich oligopeptides.

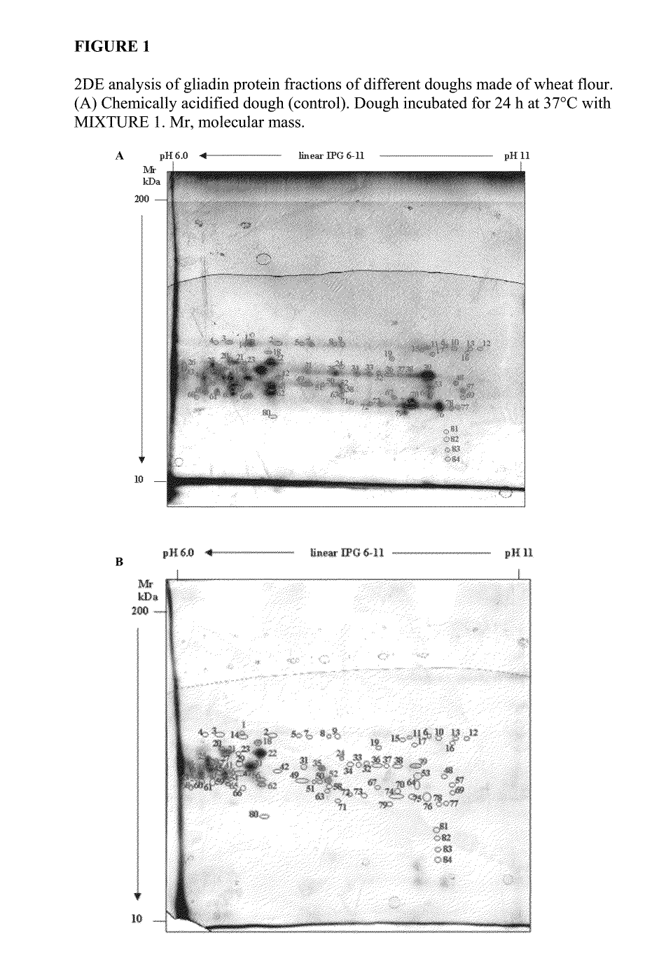

The hydrolysis of gliadin oligopeptides by MIXTURE 1 preparation during dough fermentation was further characterized by 2DE analysis. Eighty-four protein spots were identified in the chemically acidified dough used as control (FIG. 1A). Seventy-nine of the 84 gliadin oligopeptide spots were markedly degraded after dough fermentation with MIXTURE 1 compared to control (FIG. 1B). Table 2 refers to the hydrolysis factors of the spots identified by 2DE. Most of the oligopetides degraded (65 of the 79) had hydrolysis factors higher than 80% and only 8 showed hydrolysis factors lower than 40%.

TABLE 2
Properties of alcohol-soluble polypeptides hydrolyzed by
MIXTURE 1 after dough incubation at 37° C. for 24 h^{a}.

| | | Estimated molecular | Hydrolysis |
|---|---|---|---|
| Spot designation^{b} | Estimated pI | mass (kDa) | factor |
| 1 | 6.84 | 51.0 | 54.0 |
| 2 | 7.15 | 49.8 | 90.5 |
| 3 | 6.55 | 49.5 | 85.0 |
| 4 | 6.38 | 49.0 | 92.0 |
| 5 | 7.52 | 48.9 | 95.4 |
| 6 | 9.40 | 48.7 | 87.0 |
| 7 | 7.64 | 48.5 | 90.6 |
| 8 | 7.98 | 48.4 | 85.0 |
| 9 | 8.05 | 48.3 | 90.8 |
| 10 | 9.52 | 48.1 | 96.2 |
| 11 | 9.15 | 48.0 | 91.5 |
| 12 | 9.87 | 47.9 | 90.0 |
| 13 | 9.70 | 47.8 | 97.7 |
| 14 | 6.83 | 47.7 | 85.0 |
| 15 | 9.10 | 47.6 | 92.5 |
| 16 | 9.69 | 47.0 | 90.8 |
| 17 | 9.25 | 46.3 | 90.8 |
| 18 | 7.08 | 46.0 | 52.5 |
| 19 | 8.70 | 44.5 | 93.2 |
| 20 | 6.54 | 44.0 | 95.6 |
| 21 | 6.63 | 43.2 | 0.0 |
| 22 | 7.10 | 43.0 | 10.0 |
| 23 | 6.70 | 42.9 | 91.4 |
| 24 | 8.04 | 42.6 | 67.0 |
| 25 | 6.35 | 42.5 | 0.0 |
| 26 | 6.04 | 41.8 | 0.0 |
| 27 | 6.49 | 41.7 | 87.7 |
| 28 | 6.40 | 41.6 | 16.0 |
| 29 | 6.78 | 41.4 | 95.0 |
| 30 | 7.00 | 41.3 | 47.5 |
| 31 | 7.58 | 41.2 | 93.2 |
| 32 | 8.55 | 41.1 | 90.1 |
| 33 | 8.45 | 41.0 | 85.4 |
| 34 | 8.25 | 40.9 | 86.2 |
| 35 | 8.00 | 40.8 | 20.5 |
| 36 | 8.68 | 40.7 | 93.1 |
| 37 | 8.85 | 40.65 | 88.6 |
| 38 | 8.90 | 40.6 | 84.8 |
| 39 | 9.18 | 40.55 | 81.5 |
| 40 | 6.37 | 40.5 | 45.6 |
| 41 | 6.56 | 40.4 | 82.0 |
| 42 | 7.20 | 40.0 | 93.0 |
| 43 | 6.05 | 39.9 | 95.2 |
| 44 | 6.26 | 39.8 | 24.8 |
| 45 | 6.48 | 39.7 | 95.0 |
| 46 | 6.57 | 39.6 | 44.5 |
| 47 | 6.81 | 39.5 | 93.5 |
| 48 | 9.55 | 39.3 | 91.7 |
| 49 | 7.57 | 39.0 | 92.4 |
| 50 | 7.95 | 38.9 | 87.9 |
| 51 | 7.80 | 38.7 | 92.0 |
| 52 | 8.05 | 38.6 | 58.2 |
| 53 | 9.20 | 38.5 | 90.8 |
| 54 | 6.62 | 38.3 | 0.0 |
| 55 | 6.26 | 38.2 | 90.7 |
| 56 | 7.12 | 38.1 | 94.8 |
| 57 | 9.64 | 38.0 | 93.1 |
| 58 | 8.08 | 37.9 | 94.5 |
| 59 | 6.60 | 37.8 | 85.7 |
| 60 | 6.26 | 37.5 | 91.5 |
| 61 | 6.40 | 37.3 | 90.4 |
| 62 | 7.10 | 37.1 | 94.8 |
| 63 | 8.06 | 36.7 | 91.2 |
| 64 | 9.20 | 36.5 | 90.0 |
| 65 | 6.61 | 36.3 | 95.7 |
| 66 | 6.85 | 36.0 | 90.0 |
| 67 | 8.75 | 35.8 | 95.2 |
| 68 | 6.15 | 35.7 | 24.8 |
| 69 | 9.65 | 35.6 | 95.0 |
| 70 | 9.00 | 35.5 | 44.5 |
| 71 | 8.20 | 35.2 | 93.5 |
| 72 | 8.48 | 34.9 | 91.7 |
| 73 | 8.60 | 34.7 | 95.0 |
| 74 | 8.98 | 34.5 | 87.9 |
| 75 | 9.14 | 34.3 | 82.0 |
| 76 | 9.37 | 34.1 | 85.0 |
| 77 | 9.60 | 33.9 | 90.8 |
| 78 | 9.51 | 33.6 | 0.0 |
| 79 | 8.90 | 33.0 | 90.7 |
| 80 | 7.15 | 32.2 | 94.8 |
| 81 | 9.45 | 30.3 | 90.5 |
| 82 | 9.46 | 29.3 | 88.5 |
| 83 | 9.47 | 28.0 | 94.7 |
| 84 | 9.48 | 26.6 | 96.5 |

^{a}Analyses were performed with Image Master software (Pharmacia). Four gels of independent replicates were analyzed. For spot quantification and hydrolysis factor calculation, see Materials and Methods. All of the hydrolysis factors were calculated based on the average of the spot intensities of each of four gels, and standard deviations were calculated.
^{b}Spot designation corresponds to those of the gels in FIG. 1A and 1B.

The above results showed that MIXTURE 1 had the capacity to almost totally hydrolyzed gliadin oligopeptides.

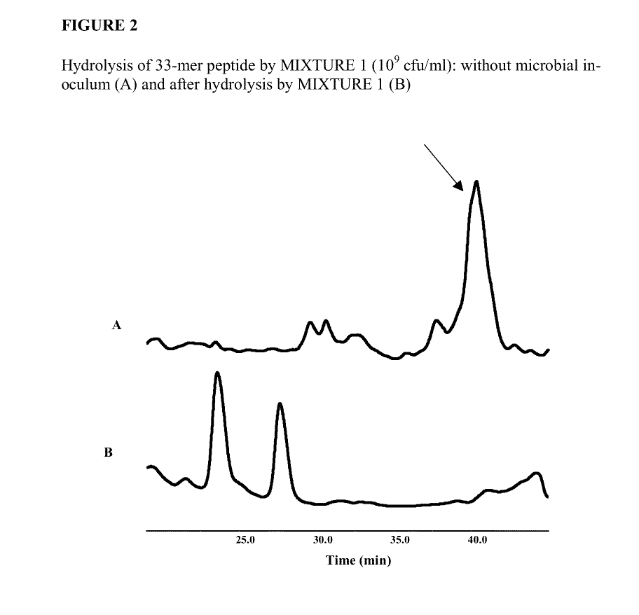

The activity of MIXTURE 1 was further in vitro characterized towards some of the oligopeptides reported in the literature as the major responsible for CS: the fragment 62-75 of the A-gliadin (Silano and De Vincenzi; 1999) and the epitope 33-mer (Shan, et al.; 2002). As shown by the RP-FPLC analysis, the fragment 62-75 of the A-gliadin, at a concentration of 450 μM, was completely hydrolyzed after 6 h of incubation with 5×10⁹ cfu/ml cells of MIXTURE 1. The epitope 33-mer, at a concentration of 200 μM, was completely hydrolyzed after 24 h of incubation with the same cell concentration of MIXTURE 1 (FIG. 2). The kinetics of hydrolysis of the 33-mer was determined by the Lineweaver-Burk plot showing a V. of 0.26 μmol per milliliter per min and a Kₘ of 216 μM. As previously reported in the literature, it should be noted that the epitope 33-mer has the following properties: (i) it remains intact despite prolonged exposure to gastric and pancreatic proteases; (ii) it shows a hydrolysis less than 20% over 20 h of incubation with small brush border membrane enzymes; and (iii) it remains intact for a long time (about 24 h) in the small intestine and even at low concentration acts as potential antigen for T-cell proliferation (Shan, et al. 2002). The above results showed that MIXTURE 1 contained the complex pool of enzyme activities needed to completely hydrolyze the 33-mer and that these activities are markedly higher than those located at the gastrointestinal level.

Compared to European gliadin references, the Western blot by R5 monoclonal antibody of Italian biscuits had the typical profile of intact gliadin. A major advantage of the R5 monoclonal antibody is its ability to recognize the consensus amino acid sequence QXPW/FP (Osman, et al.; 2001, Eur. J. Gastroenterol. Hepatol., 13: 1189-1193) corresponding to multiple immunoreactive epitope repeats, which occur in α-, γ- and ω-gliadins as well as in different wheat varieties (Shewry, et al.; 1992, Cereal's proteins and celiac disease. In: Celiac disease, Marsh M. [ed], Oxford, Blackwell Scientific Publications pp. 305-348). Greatest reactivity has been associated with the QQPFP amino acid sequence, but homologous repeats such as LQPFP, QLPYP, QLPTF, QQSFP, QQTFP, PQPPP, QQPYP and PQPFP are also recognized with a weaker reactivity to R5 antibody (Osman, et al.; 2001). It is interesting to note that three of these epitopes (LQPFP, QLPYP and PQPFP) are placed in the sequence of the potent inducer of gut-derived human T-cell lines of celiac patients, of the A-gliadin 33-mer peptide (Shan, et al.; 2002). The Western blot of the Italian biscuits fermented with the MIXTURE 1 showed an almost degradation of α-, β- and γ-gliadins recognized by R5 monoclonal antibody.

The same results were confirmed by RAPD PCR analysis.

Preliminary experiments for the identification of allergen fractions of wheat albumins and globulins indicated that 100% of the sera tested were positive against albumin and globulin fractions. Responses were found against protein components with apparent molecular masses which ranged from 15 to 70 KDa, with an intense staining for some sera around 15 to 45 KDa. As determined by mono-dimensional SDS-PAGE, the comparison of untreated albumins and globulins with that hydrolyzed by MIXTURE 1 preparation highlighted the hydrolysis of several potential allergens polypeptides.

### Example 2

The sourdough prepared according to Example 1 was used in the manufacture of baked products.

Baked products as disclosed in Examples of U.S. Pat. No. 6,884,443 were prepared by using the dough composition according to the present invention instead of the one of the patent. Fermentation was carried out at 37° C. for 24 hours as disclosed in Example 1 above and MIXTURE 1 was used.

The products resulted more digestible and suitable for subjects affected by celiac disease.

### Example 3

The sourdough prepared according to Example 1 with MIXTURE 2 was used in the manufacture of pasta.

The pasta resulted more digestible and can be taken by subjects affected by celiac disease.

### Example 4

MIXTURE 1 according to Example 1 was used in the manufacture of noodles according to the teaching of US 2002/0160093.

Examples 1-4 of US 2002/0160093 were repeated, except a packet containing a MIXTURE 1 according to the present invention was added to kansui and flour mixture. After kneading, the mixture was allowed to stand at 37° C. for 24 hours. Then noodles were prepared as disclosed in the reference.

The product resulted more digestible and suitable for subjects affected by celiac disease.

### Example 5

MIXTURE 2 according to Example 1 was used in the manufacture of noodles according to the teaching of WO 99/65331.

Examples 1-2 of WO 99/65331 were repeated, except a packet containing a MIXTURE 2 according to the present invention was added to ingredient for the dough. After mixing, the dough was allowed to stand at 37° C. for 24 hours. Then noodles were prepared as disclosed in the reference.

The product resulted more digestible and suitable for subjects affected by celiac disease.

### Example 6

MIXTURE 1 according to Example 1 was used in the manufacture of bread derivatives according to the teaching of EP 0 614 609.

Examples 1-5 of EP 0 614 609 were repeated, except a packet containing a MIXTURE 1 according to the present invention was added to dough preparation. After kneading, dough was allowed to stand at 37° C. for 24 hours. Then products were prepared as disclosed in the reference.

The product resulted more digestible and suitable for subjects affected by celiac disease.

### Example 7

MIXTURE 2 according to Example 1 was used in the manufacture of spaghetti according to the teaching of EP 1 338 209.

Example of EP 1 338 209 was repeated, except a packet containing a MIXTURE 2 according to the present invention was added to ingredient for the dough. After mixing, the dough was allowed to stand at 37° C. for 24 hours. Then noodles were prepared as disclosed in the reference.

The product resulted more digestible and suitable for subjects affected by celiac disease.

### Example 8

Ramyun

Composition:

### 1. Noodle

### Flour: 83-85%

### Refined Oil: 15-18%

### Salt: 1%

### Others: 0.6-1%

### 2. Dry Soup Base

Dried Beef Flake, Soy Sauce, Mono Sodium Glutamate, Disodium Glutamate, Flavoring Additive, Glucose, Garlic, Onion, Green Onion, Red Pepper Powder, Other ingredient for flavor

Manufacturing Process for Ramyun

Flour (sometimes starch, rice flour, barley flour can be used in a different ratio) and water are mixed according to the manufacturer's recommendation. MIXTURE 1 was added to the dough and left to stand at 37° C. for 24 hours.

Roll the mixed dough with pressing roller and then put the dough through the machine to make the individual string of noodles. The shape and thickness of the noodle can be modified to the wanted thickness and shape by adjusting the slot size of the shredding machine and also the speed of the convey belt carrying the noodle.

Noodle pass through the steam box of which temperature is more than 100° C. to induce the pregelatinized starch (α-starch) to make the digestion easier.

After the steaming process, noodle is formed into the certain shape by molding case.

Deep frying process: Depending on the type of Ramyun, the dehydration occurs through deep frying process. The noodle goes through deep frying process at 150° C. Some Ramyun does not go through this deep frying process.

After the deep frying process, the Ramyun goes through cooling process.

According to the present invention, the specific mixture of lactic acid bacteria and Bifidobacteria is suitable for the manufacturing of cereal-based food, in particular baked goods, which may be more tolerated by CS patients. In particular, the following advantages are provided:

(i) marked capacity to degrade gliadin oligopeptides during dough fermentation;
(ii) hydrolysis of 79 of the 84 gliadin oligopeptides identified by 2DE analysis;
(iii) complementary and large enzyme activities towards synthetic peptides which included proline at the different positions;
(iv) capacity to hydrolysis completely oligopeptides (fragment 62-75 of the A-gliadin and epitope 33-mer) which are responsible for CS;
(v) capacity to markedly decrease α-, β- and γ-gliadins which reacted with R5 monoclonal antibody;
(vi) capacity to hydrolyze several allergen polypeptides.
(vii) when the activity of the above bacteria is supplemented with fungal proteases and used towards 20% wheat flour under liquid fermentation, it increases strongly producing gluten-free wheat flour.

It should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

1-53. (canceled)

54. An unbaked, fermented sourdough comprising
(i)
(a) a mixture of viable lactic acid bacteria,
wherein the mixture of viable lactic acid bacteria consists essentially of:
a Lactobacillus acidophilus,
a Lactobacillus delbrueckii subsp. bulgaricus,
a Streptococcus thermophilus,
a Lactobacillus plantarum,
a Lactobacillus casei,
a Bifidobacterium breve,
a Bifidobacterium infantis, and
a Bifidobacterium longum,
(b) a fungal protease, and
(c) a flour,
wherein the sourdough has a gluten concentration lower than about 200 ppm as determined by use of the monoclonal antibody R5 able to recognize a 33-mer fragment of A-gliadin and as determined by RP-FPLC; or
(ji) the unbaked, fermented sourdough of (i), wherein one or more or all of the mixture of viable lactic acid bacteria are of human or milk origin.

55. A food comprising the unbaked, fermented sourdough of claim 54.

56. A food consisting essentially of the unbaked, fermented sourdough of claim 54.

57. A composition comprising:
(a) a mixture of viable lactic acid bacteria consisting essentially of
a Lactobacillus acidophilus,
a Lactobacillus delbrueckii subsp. bulgaricus,
a Streptococcus thermophilus,
a Lactobacillus plantarum,
a Lactobacillus casei,
a Bifidobacterium breve,
a Bifidobacterium infantis, and
a Bifidobacterium longum;
(b) the mixture of viable lactic acid bacteria of (a), and:
(i) a fungal protease,
(ii) a viable yeast, or
(iii) both a fungal protease and a viable yeast,
wherein the mixture of lactic acid bacteria and (i), (ii) or (iii) are a leavening agent composition; or
(c) the composition of (a) or (b), wherein one or more or all of the mixture of viable lactic acid bacteria are of human or milk origin.

58. A package or a kit comprising:
(i)
(a) a gluten-containing flour,
(b) a mixture of viable lactic acid bacteria, consisting essentially of:
a Lactobacillus acidophilus,
a Lactobacillus delbrueckii subsp. bulgaricus,
a Streptococcus thermophilus,
a Lactobacillus plantarum,
a Lactobacillus casei,
a Bifidobacterium breve,
a Bifidobacterium infantis, and
a Bifidobacterium longum; and
(c) a fungal protease;
(ii) the package or kit of (i), wherein:
(1) the gluten-containing flour, the mixture of viable lactic acid bacteria and the fungal protease are packaged in separated containers or packages, or are packaged together; or
(2) the mixture of viable lactic acid bacteria is packaged in a single container alone, or in admixture with the fungal protease;
(iii) the package or kit of (i) or (ii), wherein one or more or all of the mixture of viable lactic acid bacteria are of human or milk origin.

59. The unbaked, fermented sourdough of claim 54, wherein the fungal protease comprises a microbial proteolytic enzyme obtained from an Aspergillus sp.

60. The composition of claim 57, wherein the fungal protease comprises a microbial proteolytic enzyme obtained from an Aspergillus sp.

61. The package or kit of claim 58, wherein the fungal protease comprises a microbial proteolytic enzyme obtained from an Aspergillus sp.

62. A non-baked food consisting essentially of the non-baked, fermented sourdough of claim 54.

63. A fermented sourdough having a gluten concentration lower than about 200 ppm, made by a process comprising:
(a) providing a leavening composition of claim 57,
(b) providing a gluten-comprising flour,
(c) mixing the leavening composition with the gluten-comprising flour with water and incubating the mixture under conditions facilitating fermentation of the flour and hydrolysis of gliadin oligopeptides such that the sourdough is fermented and hydrolyzed to a gluten concentration lower than about 200 ppm.

64. A fermented sourdough having a gluten concentration lower than about 200 ppm, made by a process comprising:
(a) providing a package or kit of claim 58,
(b) providing a gluten-comprising flour,
(c) mixing the contents of the package or kit with the gluten-comprising flour with water and incubating the mixture under conditions facilitating fermentation of the flour and hydrolysis of gliadin oligopeptides such that the sourdough is fermented and hydrolyzed to a gluten concentration lower than about 200 ppm.

65. A baked product comprising the fermented sourdough of claim 54, wherein none of the mixture of viable lactic acid bacteria remain viable after baking.

66. The unbaked, fermented sourdough of claim 54, wherein the flour comprises a wheat flour.

67. A baked product comprising a baked fermented sourdough of claim 63, or comprising a baked product made by baking the fermented sourdough of claim 63,
wherein none of the mixture of viable lactic acid bacteria remain viable after baking.

68. A baked product comprising a baked fermented sourdough of claim 64, or comprising a baked product made by baking the fermented sourdough of claim 64,
wherein none of the mixture of viable lactic acid bacteria remain viable after baking.

69. A process for making a fermented sourdough having a gluten concentration lower than about 200 ppm comprising:
(a) providing a leavening composition of claim 57,
(b) providing a gluten-comprising flour,
(c) mixing the leavening composition with the gluten-comprising flour with water and incubating the mixture under conditions facilitating fermentation of the flour and hydrolysis of gliadin oligopeptides such that the sourdough is fermented and hydrolyzed to a gluten concentration lower than about 200 ppm,
wherein optionally the incubating conditions of the dough with the mixture of bacteria comprises about 37° C., optionally for about 24 to 31 hours,
and optionally the yeast is added to the dough after the bacteria-dough fermentation, optionally under conditions comprising about 37° C., optionally for about 2 hours,
and optionally the process further comprises partial liquid fermentation of the flour, optionally wheat flour, by addition of a fungal proteases (optionally at 200 ppm) at about 37° C., optionally for about 24 to 31 hours.

70. The process of claim 69, further comprising baking the fermented sourdough of claim 69, to produce a baked product wherein none of the mixture of viable lactic acid bacteria remain viable after baking,
wherein optionally the baking is at about 250° C. for about 20 minutes.

71. A process for making a fermented sourdough having a gluten concentration lower than about 200 ppm comprising:
(a) providing a package or kit of claim 58,
(b) providing a gluten-comprising flour,
(c) mixing the contents of the package or kit with the gluten-comprising flour with water and incubating the mixture under conditions facilitating fermentation of the flour and hydrolysis of gliadin oligopeptides such that the sourdough is fermented and hydrolyzed to a gluten concentration lower than about 200 ppm,
wherein optionally the process further comprises partial liquid fermentation of the flour, optionally wheat flour, by addition of a fungal proteases (optionally at 200 ppm) at about 37° C., optionally for about 24 to 31 hours.

72. The process of claim 71, further comprising baking the fermented sourdough of claim 71, to produce a baked product wherein none of the mixture of viable lactic acid bacteria remain viable after baking,
wherein optionally the baking is at about 250° C. for about 20 minutes.

73. The unbaked, fermented sourdough of claim 54, wherein the flour is derived from bean flour, buckwheat, flax, corn (maize), a legume flour (optionally a garbanzo, a chickpea, a lentil or a pea flour), a millet flour, an Indian Rice Grass flour, a nut flour (optionally an almond, a hazelnut or a pecan flour), a quinoa flour, a potato flour, a sweet potato flour, a sago flour, a seed flour (optionally a sesame flour), a sorghum flour, a soy flour, a tapioca flour or a teff flour.
